(19) United States
(12) Patent Application Publication
(10) Pub. No.: US 2015/0290921 A1
(43) Pub. Date: Oct. 15, 2015

(54) METHOD OF MANUFACTURING DEVICE SUBSTRATE

(71) Applicant: Samsung Display Co., Ltd., Yongin-city (KR)

(72) Inventors: TaeHwan KIM, Seongnam-si (KR); Boram LEE, Seongnam-si (KR); Jonghwan LEE, Seoul (KR); Sangil KIM, Yongin-si (KR)

(21) Appl. No.: 14/602,649

(22) Filed: Jan. 22, 2015

(30) Foreign Application Priority Data
Apr. 10, 2014 (KR) 10-2014-0043133

(51) Int. Cl. B32B 38/10; B32B 43/00

(52) U.S. Cl. CPC B32B 38/10; B32B 43/006; B32B 2307/202; B32B 2311/00

(57) ABSTRACT

A method of separating a device substrate from a carrier substrate on which said device substrate is disposed. A static electricity removal member is provided between the device substrate and the carrier substrate. The device substrate is separated from the carrier substrate. According to the above, since static electricity accumulating between the device substrate and the carrier substrate is removed by the static electricity removal member, the carrier substrate and the device substrate may be easily separated from each other. Thus, damage to the device due to static electricity when the carrier substrate and the device substrate are separated from each other may be prevented.

### CROSS-REFERENCE TO RELATED APPLICATION

This application claims priority from and the benefit of Korean Patent Application No. 10-2014-0043133, filed on Apr. 10, 2014, which is hereby incorporated by reference for all purposes as if fully set forth herein.

### BACKGROUND

1. Field

Exemplary embodiments relate to methods of manufacturing a device substrate. More particularly, the present disclosure relates to a method of manufacturing a device substrate having flexibility.

2. Discussion of the Background

A display device employing a flat panel display panel, such as a liquid crystal display, a field emission display, a plasma display panel, an organic light emitting diode, etc., is mainly applied to various electric appliances, e.g., a television set, a mobile phone, etc. In general, since the display device is manufactured using a glass substrate having no flexibility, the use of the display device is extremely limited. In recent years, there have been various suggestions for manufacture of a flexible display device. As an example, a display device, which is manufactured using plastic material and is as flexible as paper, has been developed instead of using a glass substrate having no flexibility.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a method capable of easily manufacturing a device substrate having flexibility.

Additional aspects will be set forth in the detailed description which follows, and, in part, will be apparent from the disclosure, or may be learned by practice of the inventive concept.

According to exemplary embodiments there is provided a method of separating a device substrate from a carrier substrate on which said device substrate is disposed. A static electricity removal member is provided between the device substrate and the carrier substrate. The device substrate is separated from the carrier substrate.

According to the above, since static electricity accumulating between the device substrate and the carrier substrate is removed by the static electricity removal member, the carrier substrate and the device substrate may be easily separated from each other. Thus, damage to the device due to static electricity when the carrier substrate and the device substrate are separated from each other may be prevented.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain the principles of the inventive concept.

The above and other advantages of the present disclosure will become readily apparent by reference to the following detailed description when considered in conjunction with the accompanying drawings wherein:

FIG. 1 is a flowchart showing a method of manufacturing a device substrate according to an exemplary embodiment of the present disclosure;

FIGS. 2A to 2E are cross-sectional views showing the manufacturing method of the device substrate according to an exemplary embodiment of the present disclosure;

FIG. 3 is a graph showing static electricity and an absolute value of a difference in static electricity between a carrier substrate and a process substrate when the carrier substrate and the process substrate are separated from each other in a conventional device substrate and when the carrier substrate and the process substrate are separated from each other in a device substrate according to an exemplary embodiment of the present disclosure;

FIGS. 4A and 4B are graphs showing an adhesive force as a function of a distance when the carrier substrate and the process substrate are separated from each other in a conventional device substrate and when the carrier substrate and the process substrate are separated from each other in a device substrate according to an exemplary embodiment of the present disclosure;

FIG. 5 is a perspective view showing a method of measuring the adhesive force using an adhesive force measurement device;

FIG. 6 is a view showing ions provided between the carrier substrate and the process substrate as a static electricity removal member in the manufacturing method of the device substrate according to an exemplary embodiment of the present disclosure; and

FIG. 7 is a view showing a conductive layer provided between the carrier substrate and the process substrate as a static electricity removal member in the manufacturing method of the device substrate according to an exemplary embodiment of the present disclosure.

### DETAILED DESCRIPTION OF THE ILLUSTRATIVE EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or HI intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, the present invention will be explained in detail with reference to the accompanying drawings.

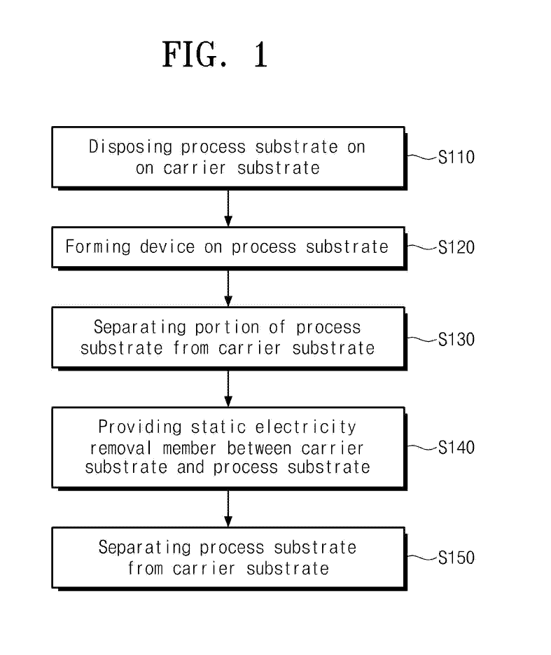

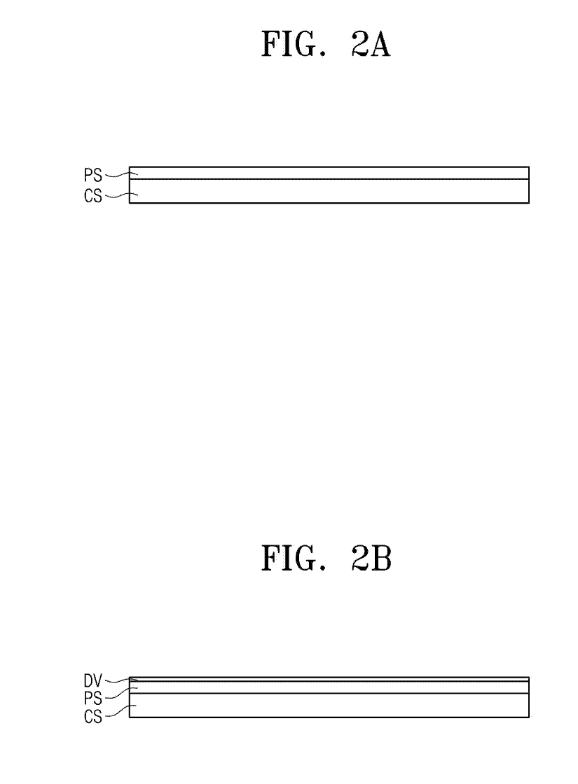

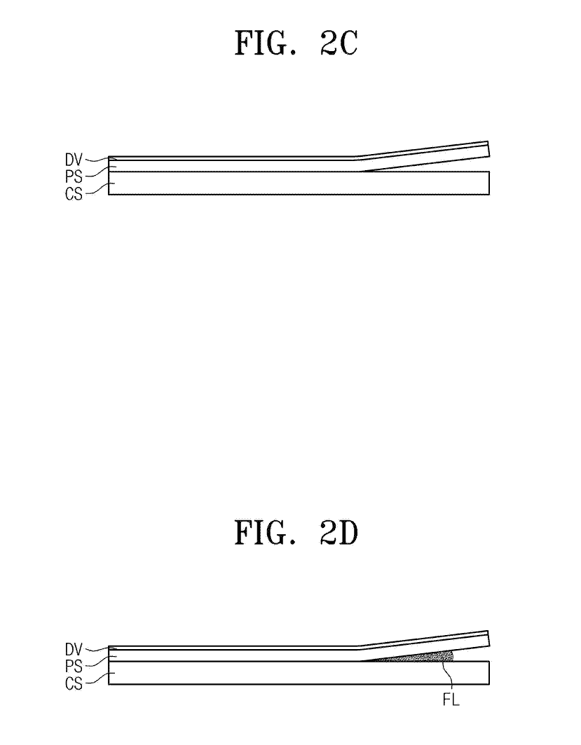

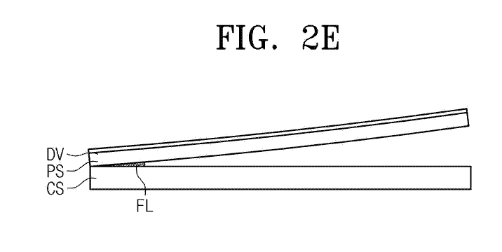

FIG. 1 is a flowchart showing a method of manufacturing a device substrate according to an exemplary embodiment of the present disclosure and FIGS. 2A to 2E are cross-sectional views showing the manufacturing method of the device substrate according to an exemplary embodiment of the present disclosure. Hereinafter, the manufacturing method of the device substrate will be described in detail with reference to FIGS. 1, 2A, and 2B.

Referring to FIG. 1, the manufacturing method of the device substrate includes disposing a carrier substrate on a process substrate (S110), forming a device on the process substrate (S120), separating a portion of the process substrate from the carrier substrate (S130), providing a static electricity removal member between the process substrate and the carrier substrate (S140), and separating the process substrate from the carrier substrate (S150).

Referring to FIGS. 1 and 2A, the process substrate PS is disposed on the carrier substrate CS. In detail, the process substrate PS is placed on an upper surface of the carrier substrate CS. In the present exemplary embodiment, the process substrate PS and the carrier substrate CS are individually prepared, and then the process substrate PS is disposed on the carrier substrate CS. As another example, the process substrate PS may be directly formed on the carrier substrate CS. Although not shown in figures, a fixing member (not shown) may be provided on the carrier substrate CS to fix the process substrate PS to the carrier substrate CS.

The process substrate PS has a plate-like shape including one surface and the other surface opposite to the one surface to accommodate the device thereon. When viewed in a plan view, the process substrate PS may have various shapes. In the present exemplary embodiment, the process substrate PS has a substantially rectangular shape with a pair of long sides and a pair of short sides. However, the shape of the process substrate PS should not be limited to a rectangular shape. For instance, the process substrate PS may have a polygonal shape, e.g., a square shape, a rectangular shape, a parallelogram shape, etc. In addition, a portion of the polygonal shape may have a curved shape, or the process substrate may have an irregular shape.

The process substrate PS may have various thicknesses depending on the use thereof. When a display apparatus is manufactured using the display device, the process substrate PS is formed to have a slim/thin thickness of about 0.3 mm or less.

The process substrate PS may be formed as a rigid substrate, but at least a portion of the process substrate PS may be formed as a pliable substrate having flexibility. For instance, the process substrate PS may have flexibility over an entire area thereof. Alternatively, the process substrate PS may have flexibility in some areas thereof and not have the flexibility in other areas. In this case, the process substrate PS is configured to include a pliable area having flexibility and a rigid area having little to no flexibility. In the pliable area and the rigid area, the terms “flexibility exists” or “flexibility does not exist” and the terms “pliable” or “rigid” indicate the relative property of the process substrate PS. The terms “flexibility does not exist” and “rigid” mean not only no flexibility exists in the rigid area, but alternatively the flexibility existing in the rigid area is smaller than that in the pliable area.

The process substrate PS may be formed of a glass, a crystalline material, an organic polymer, an organic-inorganic polymer composition, or a fiber reinforced plastic. In the present exemplary embodiment, the process substrate PS is formed of glass.

In the present exemplary embodiment, the polymer material may include polyethylene terephthalate (PET), polyethylene naphthalate (PEN), polyethersulfone (PES), polycarbonate (PC), polysulfone, phenolic resin, epoxy resin, polyester, polyimide, polyetherester, polyetheramide, cellulose acetate, aliphatic polyurethanes, polycarylonitrile, polytetrafluoroethlenes, polyvinylidene fluorides, polymethyl(methacrylates), aliphatic or cyclic polyolefin, polyarylate, polyetherimide, polyimide, a fluoropolymer such as teflon, poly(etherether ketone), poly(ether ketone), poly(ethylene tetrafluoroethylene) fluoropolymer, poly(methyle methacrylate), acrylate/methacrylatecopolymers, etc.

The carrier substrate CS may have an area equal to or greater than that of the process substrate PC to support the process substrate PC, or the carrier substrate CS may have an area smaller than that of the process substrate PS. The area of the carrier substrate CS should not be limited to a specific size as long as the carrier substrate CS stably supports the process substrate PS.

The carrier substrate CS is formed of a glass, a crystalline material, an organic polymer, an organic-inorganic polymer composition, or a fiber reinforced plastic. In the present exemplary embodiment, the carrier substrate CS is formed of glass. The carrier substrate CS has a thickness of about 0.3 mm or more to support the process substrate PC.

The carrier substrate CS may be a rigid substrate having no flexibility. However, according to another exemplary embodiment, the carrier substrate CS should not be limited to a rigid substrate. That is, at least a portion of the carrier substrate CS may be formed of a pliable substrate material having flexibility.

In the process substrate PS and the carrier substrate CS, the term that “the process substrate PS is disposed on the carrier substrate CS” as used herein means that the surface of the process substrate PS makes contact with the surface of the carrier substrate CS. A case in which the process substrate PS and the carrier substrate CS are chemically combined with each other, e.g., a covalent bond, is excluded. In addition, an additional layer such as an adhesive layer, a pressure sensitive adhesive, etc., is not disposed between the process substrate PS and the carrier substrate CS except for an air layer. Accordingly, the process substrate PS and the carrier substrate CS may be easily separated from each other by an external force without being damaged.

A debonding layer may be disposed on at least one surface of surfaces of the process substrate PS and the carrier substrate CS, which face each other, to easily separate the process substrate PS from the carrier substrate CS. The debonding layer includes a material having a hydrophobic property greater than that of the process substrate PC or the carrier substrate CS. The debonding layer is an inorganic thin film layer or a polymer resin thin film layer. For instance, the debonding layer may be a metal oxide layer or a silane-based compound layer. The metal oxide layer includes at least one of indium zinc oxide (IZO), indium tin oxide (ITO), indium tin zinc oxide (ITZO), and germanium zinc oxide (GZO), and the silane-based compound layer may be provided in a self-assembled monolayer.

Referring to FIGS. 1 and 2B, the device DV is formed on the process substrate PS.

The device DV may be various devices, e.g., a memory, a pixel, etc., according to the kinds of the devices to be formed as a product.

When the device DV is formed, the process substrate PS is loaded to or unloaded from a process chamber (not shown) while being disposed on the carrier substrate CS.

In the present exemplary embodiment, the device DV may be a pixel applied to the display apparatus. The pixel includes a signal line, a thin film transistor connected to the wiring, an electrode switched by the thin film transistor, and an image display layer controlled by the electrode.

The signal line includes a plurality of gate lines a plurality of data lines crossing the gate lines.

The thin film transistor is provided in a plural number to perform a passive matrix drive or an active matrix drive. In the case of an active matrix drive, each thin film transistor is connected to a corresponding gate line of the gate lines and a corresponding data line of the data lines.

The electrode is provided in a plural number and the electrodes are respectively connected to the thin film transistors.

Although not shown in the figures, each thin film transistor includes a gate electrode, an active layer, a source electrode, and a drain electrode. The gate electrode is branched from the corresponding gate line of the gate lines. The active layer is insulated from the gate electrode, and the source electrode and the drain electrode are disposed on the active layer to be spaced apart from each other. The source electrode is branched from a corresponding data line of the data lines.

The image display layer may be a liquid crystal layer, an electrophoretic layer, an electrowetting layer, or an organic light emitting layer according to an image display scheme thereof. The image display layer is driven in response to voltages applied to the electrode(s).

Following device formation, processes are performed to separate the process substrate PS from the carrier substrate CS. The term “separation” means that the process substrate PS making contact with the carrier substrate CS is completely separated from the carrier substrate CS by a process of removing the process substrate PS from the carrier substrate CS, or vice versa. In the case that the process substrate PS is removed from the carrier substrate CS, the process substrate PS is partially removed from the carrier substrate CS without being substantially removed in the whole surface of the carrier substrate CS. In detail, the separation of the process substrate PS begins at a start point corresponding to a portion of the process substrate PS. The distance between this portion of the process substrate PS and the carrier substrate CS increases as the separation process progresses. In the present exemplary embodiment, the start point corresponds to one of vertices of the process substrate PS, but it should not be limited to the vertices. For example, the start point may be one side of the process substrate PS.

Referring to FIGS. 1 and 2C, the portion of the process substrate PS is first separated from the carrier substrate CS.

The separation of the portion of the process substrate PS from the carrier substrate CS may be performed in various ways. For instance, when a blade is inserted into an interface between the process substrate PS and the carrier substrate CS, a gap is formed between the process substrate PS and the carrier substrate CS. Then, a force is applied to at least one of the two substrates PS and CS along a direction substantially perpendicular to the process substrate PS and the carrier substrate CS.

Referring to FIGS. 1 and 2D, a static electricity removal member is provided between the process substrate PS and the carrier substrate CS.

The static electricity removal member may have various shapes and include various materials to remove the static electricity occurring between the process substrate PS and the carrier substrate CS.

In the present exemplary embodiment, the static electricity removal member may be provided in a fluid form FL such as a liquid. The static electricity removal member may be water or ionic water in which ions are included. The ions should not be limited to a specific ion.

In the present exemplary embodiment, the fluid FL may be released onto at least one surface of the surfaces of the carrier substrate CS and the process substrate PS by using a fluid supply device, e.g., a pipette.

In the present exemplary embodiment, the fluid FL may be sprayed between the carrier substrate CS and the process substrate PS using a fluid supply member such as a sprayer. In this case, the fluid FL is sprayed between the carrier substrate CS and the process substrate PS as micro-droplets through the sprayer. The micro-droplets are provided to at least one surface of the surfaces of the carrier substrate CS and the process substrate PS.

The fluid FL provided between the carrier substrate CS and the process substrate PS moves along the interface between the carrier substrate CS and the process substrate PS by a capillary phenomenon. In particular, when the carrier substrate CS and the process substrate PS are sequentially separated from each other, a capillary tube is formed at a boundary between the area in which the carrier substrate CS and the process substrate PS are separated from each other and the area in which the carrier substrate CS and the process substrate PS are not separated from each other, and the fluid FL moves through the capillary tube. The fluid FL serves as a path through which electric charges accumulated on the carrier substrate CS and the process substrate PS flow between the carrier substrate CS and the process substrate PS, and thus the electric charges are removed from the carrier substrate CS and the process substrate PS. As a result, the static electricity accumulated between the carrier substrate CS and the process substrate PS is reduced or removed by the fluid FL.

Referring to FIGS. 1 and 2E, the process substrate PS is separated from the carrier substrate CS. In this case, the process substrate PS is separated from the carrier substrate CS or the carrier substrate CS is separated from the process substrate PS. FIG. 2E shows the process substrate PS separated from the carrier substrate CS.

Consequently, since the static electricity occurring between the process substrate PS and the carrier substrate CS is removed by the static electricity removal member, the process substrate PS may be easily separated from the carrier substrate CS. In addition, the device may be prevented from being damaged due to static electricity when the process substrate PS is separated from the carrier substrate CS.

Table 1 shown below depicts the static electricity and an absolute value of a difference in static electricity between the carrier substrate and the process substrate when the carrier substrate and the process substrate are separated from each other in a conventional device substrate and when the carrier substrate and the process substrate are separated from each other according to the present disclosure. Table 1 shows values of the static electricity measured on each surface of the carrier substrate and the process substrate by a static electricity measuring device after the process substrate and the carrier substrate are completely separated from each other.

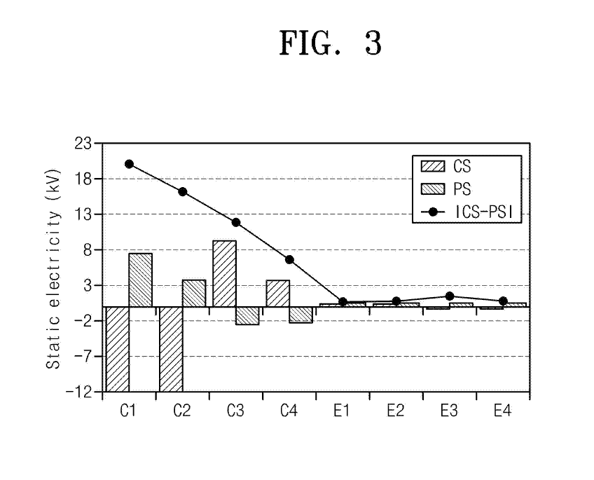

FIG. 3 is a graph showing the values shown in Table 1. In FIG. 3, the static electricity of the carrier substrate is represented by a bar graph indicated by “CS” and the static electricity of the process substrate is represented by a bar graph indicated by “PS”. In FIG. 3, “|CS-PS|” represents the absolute value of the difference in static electricity between the carrier substrate and the process substrate.

TABLE 1

| | Carrier | Process | \|Carrier substrate − |
|---|---|---|---|
| | substrate | substrate | Process substrate\| |
| Static electricity | (kV) | (kV) | (kV) |
| First comparison | −12 | 7.5 | 19.5 |
| example | | | |
| Second comparison | −12 | 4.2 | 16.2 |
| example | | | |
| Third comparison | 10 | −2.3 | 12.3 |
| example | | | |
| Fourth comparison | 4.1 | −2.2 | 6.3 |
| example | | | |
| First embodiment | 0.4 | 0.6 | 0.2 |
| example | | | |
| Second embodiment | 0.2 | 0.6 | 0.4 |
| example | | | |
| Third embodiment | −0.13 | 0.65 | 0.78 |
| example | | | |
| Fourth embodiment | −0.02 | 0.5 | 0.52 |
| example | | | |

In Table 1 and FIG. 3, the static electricity is measured on the surfaces of the carrier surface CS and the process surface PS, which face each other. As a static electricity measuring device, a static electricity measuring device 257D, which is manufactured by SINDOTECH Co., Ltd., is used. A maximum measurement limitation of the static electricity measuring device manufactured by SINDOTECH Co., Ltd. is in a range from about −12 kV to about +12 kV. When the measured static electricity exceeds the range, the static electricity is represented by a maximum value (about −12 kV) or minimum value (about +12 kV).

In Table 1, the first to fourth comparison examples indicated by C1 to C4 in FIG. 3 represent the static electricity when the process substrate and the carrier substrate are separated from each other in a conventional device substrate. The first and second comparison examples represent the static electricity when a glass substrate is applied to both of the process substrate and the carrier substrate, and the third and fourth comparison examples represent the static electricity when a glass substrate is applied to both of the process substrate and the carrier substrate and an inorganic layer, e.g., ITO, is disposed between the process substrate and the carrier substrate as the debonding layer. The debonding layer has a thickness of about 200 angstroms.

The first to fourth embodiment examples indicated by E1 to E4 in FIG. 3 represent the static electricity when the process substrate and the carrier substrate are separated from each other in the device substrate according to the present exemplary embodiments of the present disclosure. In the present exemplary embodiments, water is provided between the process substrate and the carrier substrate when the process substrate and the carrier substrate are separated from each other. The first and second embodiment examples represent the static electricity when a glass substrate is applied to both of the process substrate and the carrier substrate, and the third and fourth embodiment examples represent the static electricity when a glass substrate is applied to both of the process substrate and the carrier substrate and an inorganic layer is disposed between the process substrate and the carrier substrate as a debonding layer. The debonding layer has a thickness of about 200 angstroms.

In the first to fourth comparison examples and the first to fourth embodiment examples, each carrier substrate has a size of 0.7 mm×370 mm×470 mm and each process substrate has a size of 0.1 mm×365 mm×465 mm.

Referring to Table 1 and FIG. 3, the difference in static electricity between the carrier substrate and the process substrate is extremely large in the first and second comparison examples in which the process substrate is separated from the carrier substrate without using the debonding layer. In particular, the static electricity of the carrier substrate is measured at about −12 kV in the first and second comparison examples, which is equal to the maximum measurement limitation of the static electricity measuring device. This means that the static electricity measured on the carrier substrate is at least equal to about −12 kV or has a negative value larger than the maximum measurement limitation of the static electricity measuring device. When the absolute values of the difference in static electricity between the carrier substrate and the process substrate are obtained based on the assumption that the static electricity of the carrier substrate is about −12 kV, the absolute values are respectively about 19.5 kV and 16.2 kV in the first and second comparison examples. As the absolute value becomes large, an attraction force between the carrier substrate and the process substrate becomes large due to the electric charges. In other words, since the attraction force becomes extremely large between the carrier substrate and the process substrate when the carrier substrate and the process substrate are separated from each other using a conventional separation method, it is difficult to separate the carrier substrate from the process substrate.

In the third and fourth comparison examples each in which the inorganic layer is disposed between the carrier substrate and the process substrate, the absolute value of the difference in static electricity between the carrier substrate and the process substrate is smaller than that of each of the first and second comparison examples, but still extremely large, e.g., about 12.3 kV and about 6.3 kV.

When compared to the static electricity of the first and second comparison examples, the static electricity of the carrier substrate and the process substrate in the first and second embodiment examples in which the process substrate is separated from the carrier substrate without using the debonding layer converges to 0 kV, and the absolute value of the difference in static electricity between the carrier substrate and the process substrate is considerably reduced compared to that of the first and second comparison examples. That is, the absolute values of the difference in static electricity between the carrier substrate and the process substrate are respectively about 0.2 kV and about 0.4 kV in the first and second embodiment examples.

In addition, the static electricity of the carrier substrate and the process substrate converges to 0 kV in the third and fourth embodiment examples each in which the inorganic layer is disposed between the carrier substrate and the process substrate as the debonding layer. The absolute values, e.g., about 0.78 kV and about 0.52 kV, of the difference in static electricity between the carrier substrate and the process substrate are larger than those in the first and second embodiment examples, but much smaller than those in the first to fourth comparison examples.

As described above, when water is provided between the carrier substrate and the process substrate as the static electricity removal member, the static electricity occurring between the carrier substrate and the process substrate due to electrification during the separation process may be removed, i.e., neutralized, and thus the carrier substrate and the process substrate may be easily separated from each other.

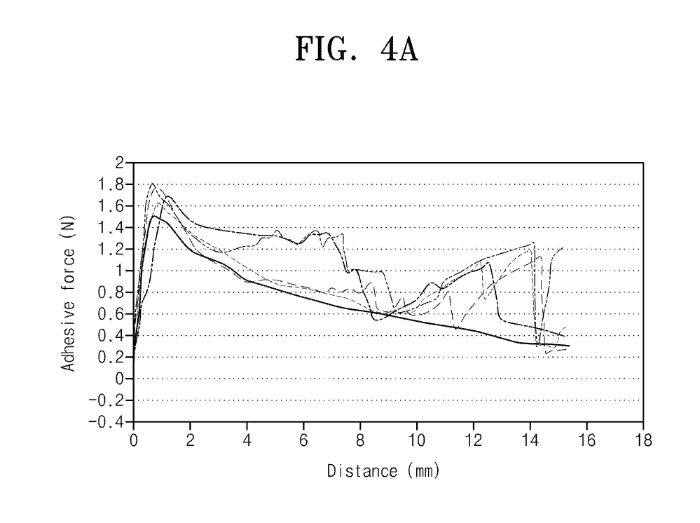

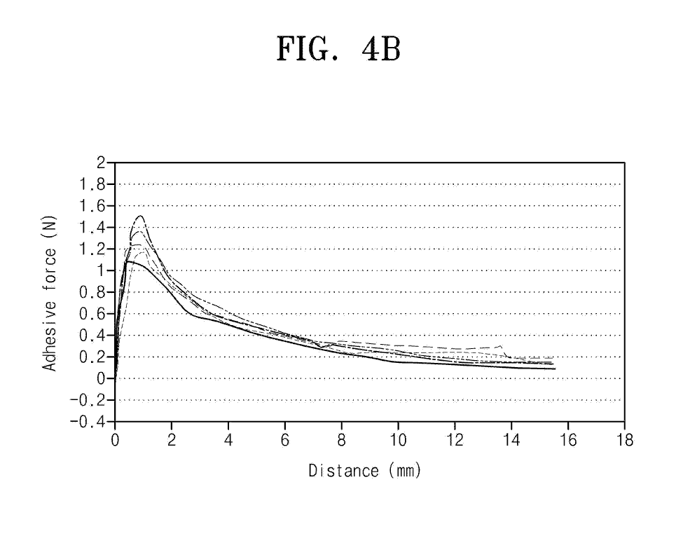

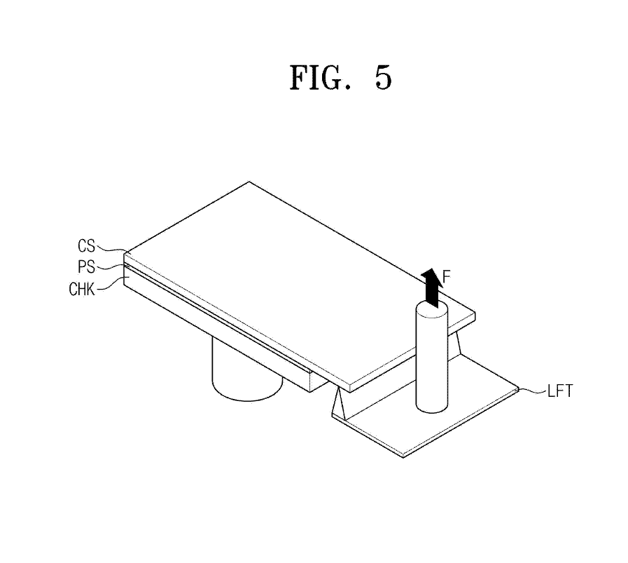

FIGS. 4A and 4B are graphs showing an adhesive force as a function of a distance when the carrier substrate and the process substrate are separated from each other in a conventional device substrate separation process and when the carrier substrate and the process substrate are separated from each other in a device substrate according to an exemplary embodiment of the present disclosure. The adhesive force is measured several times and represented by different lines, and FIGS. 4A and 4B show five graphs to represent the adhesive force measured five times. FIG. 5 is a perspective view showing a method of measuring the adhesive force using an adhesive force measurement device.

In FIGS. 4A and 4B, the distance in an x-axis direction indicates a distance between the start point at which the separation between the process substrate and the carrier substrate starts and the boundary between the area in which the carrier substrate and the process substrate are separated from each other and the area in which the carrier substrate and the process substrate are not separated from each other.

In FIGS. 4A and 4B, the adhesive force in a y-axis direction is measured using an adhesive force measurement device shown in FIG. 5 and measured in the unit of newtons (N).

Referring to FIG. 5, the process substrate PS is disposed on the carrier substrate CS and the process substrate PS is placed on a chuck CHK. Then, a force F is applied to the carrier substrate CS using a lift LFT along a direction, i.e., an upward direction, substantially vertical to the upper surface of the carrier substrate CS. The force is applied to the carrier substrate CS by the lift LFT until the carrier substrate CS is separated from the process substrate PS, and the force indicates the adhesive force. In FIG. 5, the process substrate PS makes contact with the carrier substrate CS, and the process substrate PS and the carrier substrate CS are disposed on the chuck CHK to allow the process substrate PS to make contact with the upper surface of the chuck CHK, but they should not be limited thereto or thereby.

Referring to FIG. 4A, when the carrier substrate and the process substrate are separated from each other using the conventional separation method, a maximum value of the adhesive force is in a range from about 1.4N to about 1.8N. In addition, a maximum value of the adhesive force over the distance range, in which the adhesive force is measured, is about 0.2N or more. In the distance range, a maximum average value of the adhesive force is about 1.66N and a minimum average value of the adhesive force is about 0.69N.

Referring to FIG. 4B, when the carrier substrate and the process substrate are separated from each other using the separation method according to the present exemplary embodiment, a maximum value of the adhesive force is in a range from about 1N to about 1.5N. In addition, a maximum average value of the adhesive force is about 1.66N and a minimum average value of the adhesive force is about 0.69N over the distance range.

Referring to FIG. 4A again, in a case in which the carrier substrate and the process substrate are separated from each other using a conventional separation method, the adhesive force tends to decrease when the distance increases, but variations in the adhesive force are large and unpredictable according to the first to fourth comparison examples. This is because the variations are determined depending on the accumulated electric charges when the carrier substrate and the process substrate are separated from each other.

In contrast, referring to FIG. 4B, in a case in which the carrier substrate and the process substrate are separated from each other using the separation method according to the present exemplary embodiment, the adhesive force is definitely reduced when the distance increases, and the reduction in the adhesive force is constant regardless of the distance in the first to fourth embodiment examples.

As described above, when the carrier substrate and the process substrate are separated from each other using the separation method according to the present exemplary embodiment, the carrier substrate and the process substrate may be easily separated from each other since the adhesive force becomes smaller and is uniformly reduced compared to that of the comparison examples.

In the present exemplary embodiment, the static electricity removal member may be a fluid such as water, but it should not be limited thereto or thereby.

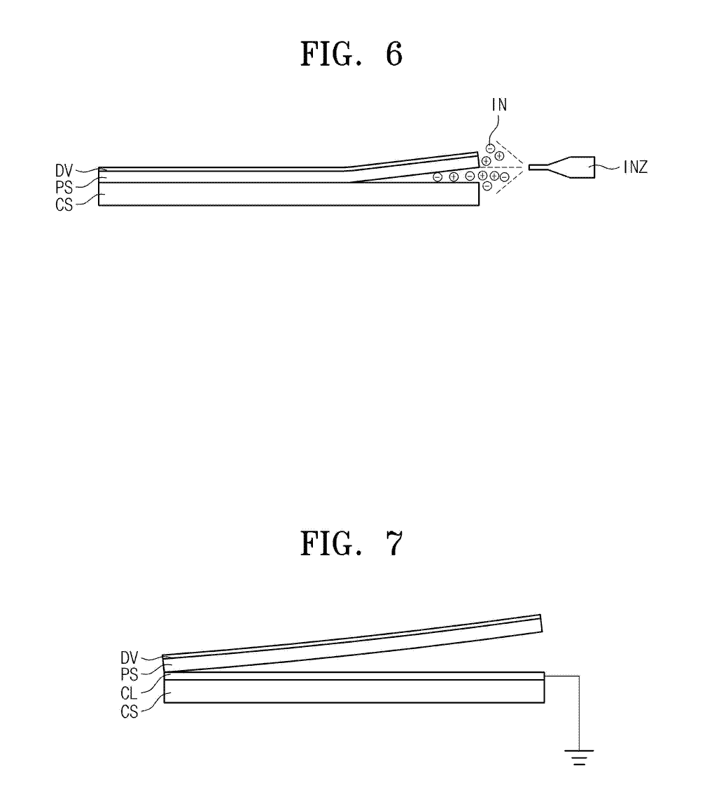

FIG. 6 is a view showing ions provided between the carrier substrate and the process substrate as the static electricity removal member in the manufacturing method of the device substrate according to an exemplary embodiment of the present disclosure.

Referring to FIG. 6, the ions IN are formed by an ion supply device INZ. The ions IN are provided between the carrier substrate CS and the process substrate PS using the ion supply device INZ, and thus the static electricity occurring between the carrier substrate CS and the process substrate PS is reduced. The ions IN neutralize the static electricity occurring on the carrier substrate CS and the process substrate PS. The ion supply device INZ should not be limited to a specific type of ion supply devices as long as the ion supply device INZ generates the ions IN. For instance, SIB3-330RD or SBP-2R, which is manufactured by SUNJE-HIGTECH Co., Ltd., may be used as the ion supply device INZ.

When the ions IN are provided as the static electricity removal member, the ions IN are provided to the start point at which the carrier substrate CS and the process substrate PS start to be separated from each other, but they should not be limited thereto or thereby. That is, the ions IN may be continuously provided to the separation interface between the carrier substrate CS and the process substrate PS while the carrier substrate CS and the process substrate PS are separated from each other. When water or ionic water are used as the static electricity removal member, the water and the ionic water move along the capillary formed between the carrier substrate CS and the process substrate PS to remove the static electricity. However, since the ions IN may not move along the capillary, ions IN are optionally continuously provided between the carrier substrate CS and the process substrate PS.

In the present exemplary embodiment, the static electricity removal member may be provided in a thin layer shape.

FIG. 7 is a view showing a conductive layer provided between the carrier substrate and the process substrate as the static electricity removal member in the manufacturing method of the device substrate according to an exemplary embodiment of the present disclosure.

Referring to FIG. 7, the static electricity removal member may be a conductive layer CL provided on the carrier substrate CS. The conductive layer CL may be grounded when the carrier substrate CS and the process substrate PS are separated from each other. When the conductive layer CL is grounded, the electric charges generated between the carrier substrate CS and the process substrate PS may be removed through the grounded conductive layer CL. Therefore, the attraction force between the carrier substrate CS and the process substrate PS, which is caused by static electricity, is reduced, and thus the carrier substrate CS and the process substrate PS may be easily separated from each other.

The conductive layer CL should not be limited to a specific material as long as the conductive layer CL has conductivity. For instance, the conductive layer CL may include a metal material or a metal oxide material. When the debonding layer is formed of a conductive metal oxide material, the debonding layer may be used as the conductive layer CL in the present exemplary embodiment. In this case, the conductive layer CL may be substantially the same as the debonding layer except that the conductive layer CL is grounded.

According to the present exemplary embodiment, the static electricity may be reduced when the carrier substrate CS and the process substrate PS are separated from each other, and thus the carrier substrate CS and the process substrate PS may be easily separated from each other. As a result, damage to the process substrate PS may be prevented.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A method of separating a device substrate from a carrier substrate on which said device substrate is disposed, comprising:
providing a static electricity removal member between the device substrate and the carrier substrate; and
separating the device substrate from the carrier substrate.

2. The method of claim 1, wherein the static electricity removal member is provided in a fluid.

3. The method of claim 2, wherein the fluid is provided on at least one of the carrier substrate and the device substrate.

4. The method of claim 2, wherein the fluid is sprayed between the carrier substrate and the device substrate.

5. The method of claim 2, wherein the static electricity removal member is water.

6. The method of claim 5, wherein the static electricity removal member is an ionic water.

7. The method of claim 2, wherein the static electricity removal member is an ion.

8. The method of claim 1, wherein the static electricity removal member is a grounded conductive layer provided between the carrier substrate and the device substrate.

9. The method of claim 8, wherein the conductive layer comprises a metal material or a metal oxide material.

10. The method of claim 1, further comprising a debonding layer formed on the device substrate or the carrier substrate.

11. The method of claim 10, wherein the debonding layer has a hydrophobic property greater than the device substrate or the carrier substrate.

12. The method of claim 1, wherein the device substrate is flexible.

13. The method of claim 1, wherein each of the device substrate and the carrier substrate comprises a glass or a polymer resin.

14. The method of claim 1, wherein the portion of the device substrate is separated from the carrier substrate by inserting a blade between the process substrate and the carrier substrate.
